(19) United States
(12) Patent Application Publication
(10) Pub. No.: US 2017/0347702 A1
(43) Pub. Date: Dec. 7, 2017

(54) Hookah Holder

(71) Applicant: Bilikian-Attie Inc., dba, Golden Desert

(72) Inventor: Elie Bilikian, Glendale, CA (US)

(21) Appl. No.: 15/170,186

(22) Filed: Jun. 1, 2016

(51) Int. Cl. A24F 1/30; A24F 9/14; B29C 39/02; B29C 39/00; B29L 31/00; B29K 83/00

(52) U.S. Cl. CPC A24F 1/30; B29C 39/02; B29C 39/003; A24F 9/14; B29K 2083/00; B29L 2031/7414

(57) ABSTRACT

Provided is a hookah holder comprising: a) a ring configured for accepting a base of a hookah; b) a plurality of connectors on a bottom of the ring for securing the ring to a surface; wherein the hookah's base in placed inside of the ring and is secured by the hookah holder. The connector can be a suction cup. The suction cups can be spaced apart and arranged in a concentric fashion in relation to the ring. The hookah holder can be made from silicone. The hookah holder can be fabricated from one piece. The hookah holder can be manufactured by casting silicone in a cast. The ring can have a diameter of about 100 mm to about 200 mm. The cavity can be formed inside of the ring and be configured to receive a hookah base. The ring can have an upper portion and a lower portion, with a cavity formed by the upper and the lower portion, the cavity configured to receive a hookah base. The lower portion can extend more towards center of the ring than the upper portion. The cavity can have a shape of a V with a curved bottom.

### BACKGROUND SECTION OF THE INVENTION

A hookah—also known as a Pneumatic Water-Pipe is a single or multi-stemmed instrument for vaporizing and smoking flavored tobacco, called shisha, whose vapor or smoke is passed through a water basin-often glass-based-before inhalation. A problem with hookahs is that they typically have a small base and are tall, leading to a high center of gravity and a chance of being knocked down. Since Hookah's are made of glass and often times placed on the ground, the chances of a person knocking down the hookah by acceding and breaking it is high. There is a need in the art to minimize the risk of a hookah tipping over and breaking.

### SUMMARY SECTION OF THE INVENTION

Provided is a hookah holder comprising: a) a ring configured for accepting a base of a hookah; b) a plurality of connectors on a bottom of the ring for securing the ring to a surface; wherein the hookah's base in placed inside of the ring and is secured by the hookah holder. The connector can be a suction cup. The suction cups can be spaced apart and arranged in a concentric fashion in relation to the ring. The hookah holder can be made from silicone. The hookah holder can be fabricated from one piece. The hookah holder can be manufactured by casting silicone into a cast. The ring can have a diameter of about 100 mm to about 200 mm. The ring can have a cavity running along the ring, the cavity configured to receive the hookah. The ring can have an upper portion and a lower portion, with a cavity formed in between the upper and the lower portion, the cavity configured to receive a hookah base. The lower portion can extend more towards center of the ring than the upper portion. The cavity can have a shape of a V with a curved bottom, and an opening towards the center of the ring.

Provided is a hookah holder comprising: a) a ring configured for accepting a base of a hookah, a bottom of the ring closed, and a top of the ring open and accessible for placement of the hookah; b) a plurality of connectors on the bottom of the ring for securing the ring to a surface; wherein the hookah's in placed inside of the ring and is secured by the hookah holder. A cavity can run along inside of the ring. The connector can be a suction cup. The hookah holder can be made from silicone. The hookah holder can be fabricated from one piece. The ring can have a diameter of about 100 mm to about 200 mm. The hookah holder can be stretchable by a finger in a horizontal direction. The ring can have an upper portion and a lower portion, with a cavity formed in between the upper and the lower portion, the cavity configured to receive the hookah.

Provided is a one piece fabricated hookah holder comprising: a) a ring configured for accepting a base of a hookah, the ring having a cavity inside, the cavity of the ring having an opening, in a direction of center of the ring, running along the ring, and b) a plurality of connectors placed on a bottom of the ring for securing the ring to a surface; wherein the hookah is fabricated from silicone; wherein the hookah in placed inside of the ring and is secured by the hookah holder.

### BRIEF DESCRIPTION OF THE FIGURES

FIG. 1 illustrates a hookah being placed inside of a hookah holder by stretching the hookah holder by hand.

FIG. 2 illustrates a top perspective view of the hookah holder.

FIG. 3 illustrates a bottom perspective view of the hookah holder.

FIG. 4 illustrates a top plan view of the hookah holder.

FIG. 5 illustrates a bottom plan view of the hookah holder.

FIG. 6 illustrates a side view of the hookah holder.

FIG. 7 illustrates a cross-sectional view of the hookah holder.

FIG. 8 illustrates a top perspective view of a hookah holder with a solid bottom lacking an opening.

FIG. 9 illustrates a top plan view of a hookah holder with a solid bottom lacking an opening.

### DETAILED DESCRIPTION SECTION OF THE INVENTION

Provided is a hookah holder to stabilize and/or attach a hookah on a surface to minimize the hookah from being knocked down.

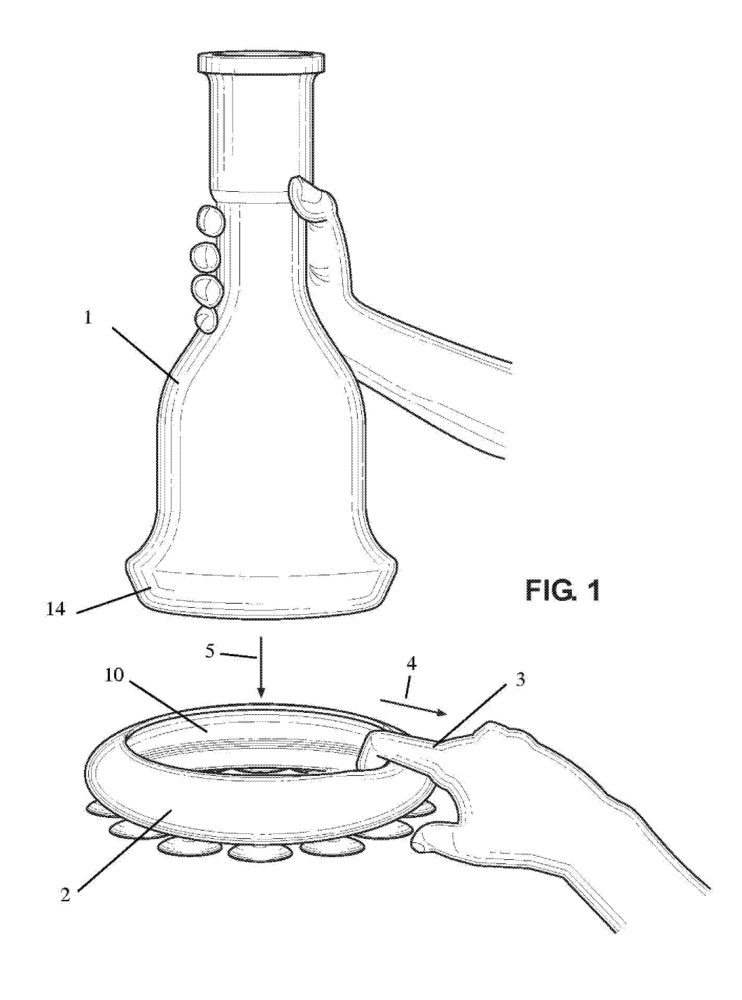

FIG. 1 illustrates base 14 of hookah 1 being placed in the hookah holder 2. The hookah holder 2 is typically made from a stretchable material, such as silicone. A user stretches the hookah holder 2 in a generally horizontal direction 4 by hand 3 to place the hookah 1 inside the hookah holder 2, in a vertical fashion 5. After placement of the hookah 1, the person lets go of the hookah holder 2, and the elastic/stretchable nature of its material is configured in such way that the hookah holder 2 retains the shape it had before being stretched. The person can place hookah 1 in hookah holder 2 and then attach hookah holder 2 to a surface, or vice versa.

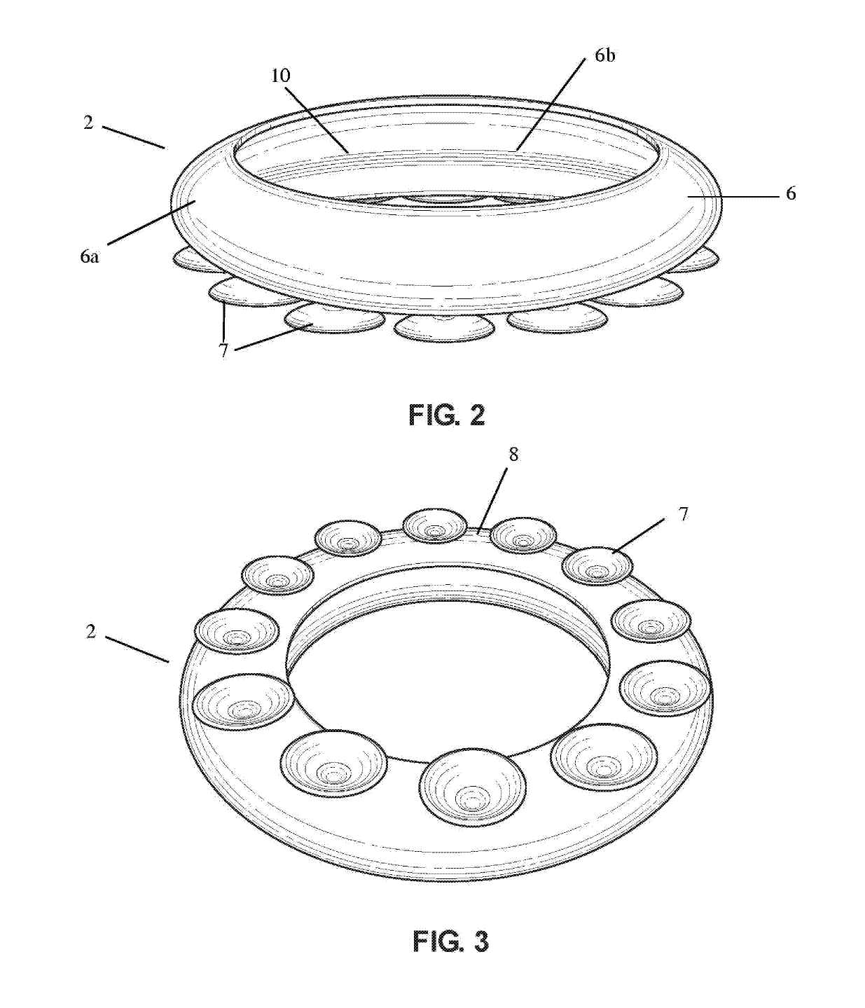

FIG. 2 illustrates a top perspective view of the hookah holder 2. Hookah holder 2 is made from a first part in a form of a ring 6 that contacts base of hookah 1 and holds hookah 1 inside. Situated below ring portion 6 is a plurality of connectors, in this case in form of suction cups 7, which are configured to secure hookah 1 to a surface, such as a floor or a table. A suction cup 7 is an object that uses the negative fluid pressure of air to adhere to nonporous surfaces, creating a partial vacuum. The ring portion 6 can be have a curved form, with outside of ring 6a bulging and inside 6b of ring 6 having a cavity 10 formed from the bulging. Cavity 10 inside the ring 6 is configured to receive base of a hookah 1.

Cavity 10 runs along the ring. Cavity 10 is enclosed on the outer edge, and has an opening that runs along the ring. The opening is generally oriented towards the center of the ring.

FIG. 3 illustrates a bottom perspective view and FIG. 5 illustrates a bottom view of hookah holder 2. Bottom portion 8 of ring 6 can be relatively flat. Connectors, in this case suction cups 7, can be arranged all around bottom portion 8 of ring 6. Different arrangements of suction cups 7 can also be made as desired.

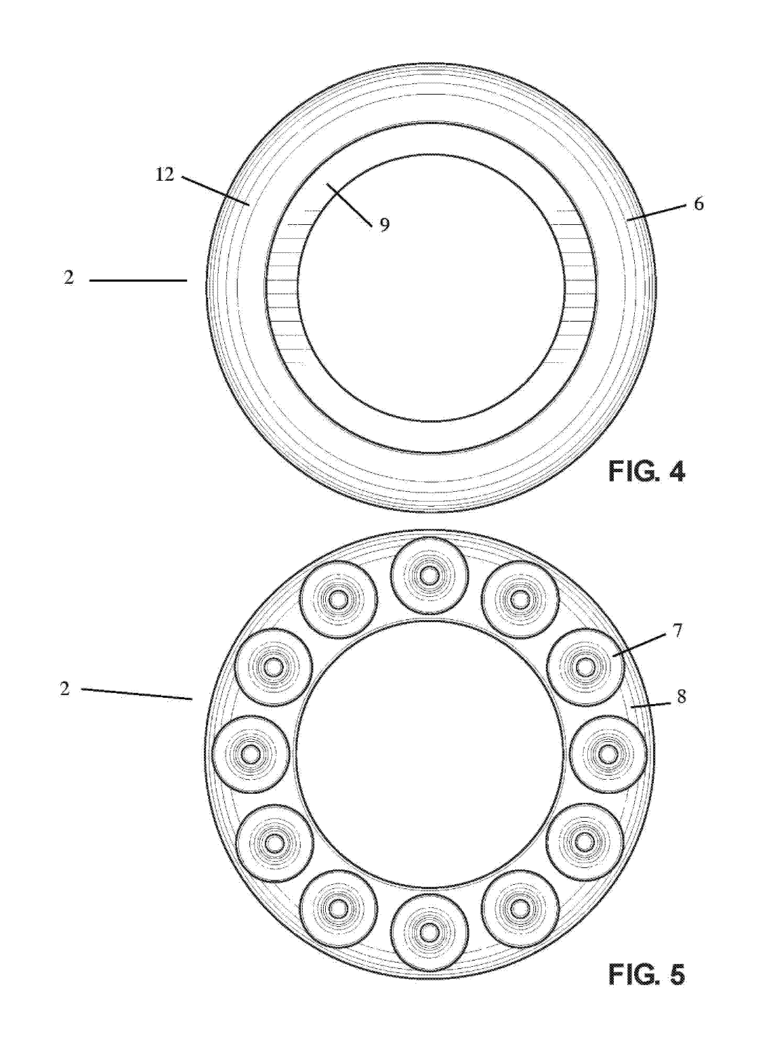

FIG. 4 illustrates a top view of hookah holder 2. In this top view, the bottom ring portion 8 is shown to extend further 9 towards the center of the ring 6 than the top of the ring portion.

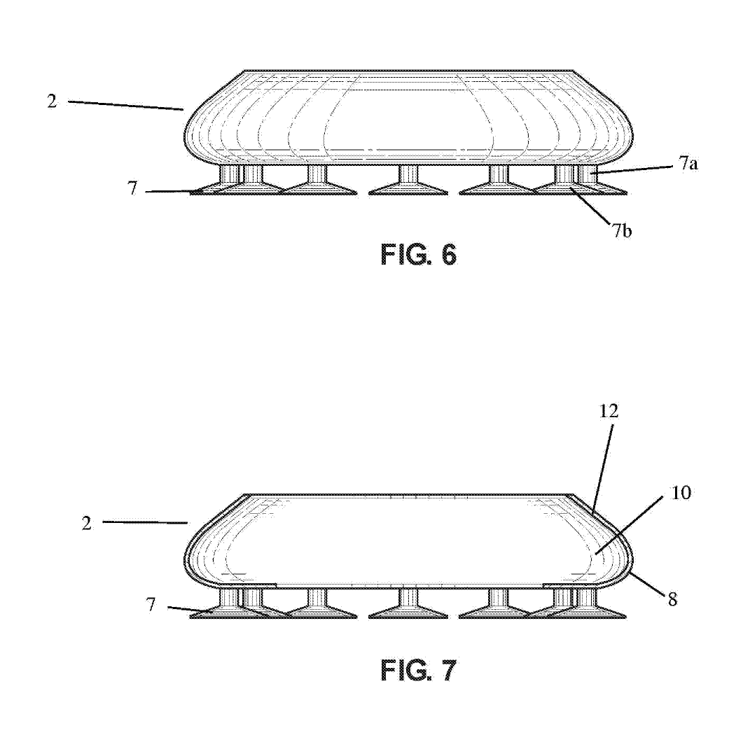

FIG. 6 illustrates a side view of the hookah holder. Visible in this view is the bulge of ring portion 6. Also visible is the stem 7a and cup 7b of suction cup 7. Cup 7b makes contact with a surface and is connected to ring 6 via stem 7a.

FIG. 7 illustrates a cross-section view of hookah base 2. Inside ring portion 6a has a cavity 10. Cavity 10 runs along the periphery of ring portion 10a on the inside and is configured to be complementary to a hookah base, and to accept and secure a hookah base. The sides of the ring portion are illustrated with a U having arms that extend out, or alternatively a V with a curved bottom.

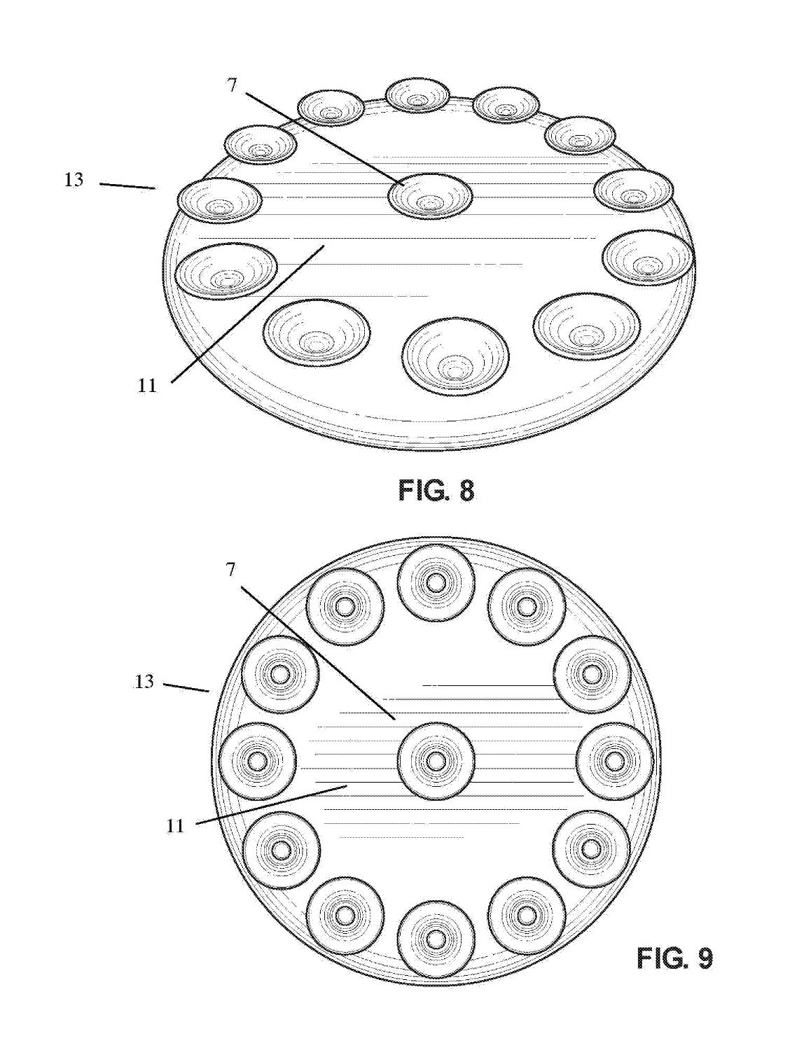

FIGS. 8 and 9 are bottom perspective view and bottom plan view of hookah holder 13 with a solid bottom. Hookah holder 13 has the same characteristics as hookah holder 2 except that hookah holder 13 has a solid bottom, and lacks the opening at the bottom of ring portion 6. One or more suction cups 7 in different arrangements can be attached to solid bottom 11.

The hookah holder 2 or 13 can be fabricated as a one piece article of manufacture by casting a suitable material into a mold. No adhesive or stings or fastener is needed to attach the ring portion to the suction cups since the holder is made from one piece. Examples of suitable materials include silicone, plastic, polyurethane, and rubber. Materials that result in a product that is elastic/stretchable are preferred. The most common silicone compounds used for mold are mixed in two parts (a base and a catalyst) to induce curing. The silicone mixture is poured into a cast, and then reinforced between layers for increased strength and tear resistance.

Hookah holder 2 or 13 can be made of a suitable size to accept the base of a hookah 1. The diameter (measured from the outside edge of the ring) of hookah holder 2 or 13 can be about 100 mm to be 200 mm, or about 160 mm. The top or bottom of the ring portion can be 15 mm to 35 mm, such as about 26-27 mm. The bottom portion can extend 4 mm or 8 mm, such as about 6 mm more inward, further towards the center that the top portion. The measurements are done in a horizontal plane while the hookah holder is placed on a horizontal surface (other than for height which is done in a vertical portion). The top and bottom portion of the ring are determined visually. FIG. 4 illustrates top portion of the ring and the bottom portion extension. FIG. 5 illustrates the bottom portion of the ring. The height of the ring portion can be about 20 mm to about 30 mm, such as about 25 mm. The height of connectors (suction cups) can be about 4 mm to about 8 mm, such as about 5 mm. The height of the hookah holder can be about 20 mm to about 50 mm, such as about 30 mm.

All measurements are done with the suction cups 7 in an undeployed position (not attached to a surface).

### REFERENCE

1. Hookah
2. Hookah holder
3. finger/hand
4. horizontal direction
5. vertical direction
6. ring portion
6a. outside of ring portion
6b. inside of ring portion
7. suction cup
7a. stem of suction cup
7b. cup of suction cup
8. bottom portion of ring
9. extended bottom ring portion
10. cavity inside of ring portion
11. Solid bottom of hookah holder
12. Top portion of ring
13. hookah holder with solid bottom
14. base portion of a hookah

What is claimed is:

1. A hookah holder comprising:
a) a ring configured for accepting a base of a hookah;
b) a plurality of connectors on a bottom of the ring for securing the ring to a surface;
wherein the hookah's base in placed inside of the ring and is secured by the hookah holder.

2. The hookah holder of claim 1, wherein the connector is a suction cup.

3. The hookah holder of claim 2, wherein the suction cups are spaced apart and arranged in a concentric fashion in relation to the ring.

4. The hookah holder of claim 1, wherein the hookah holder is made from silicone.

5. The hookah holder of claim 1, wherein the hookah holder is fabricated from one piece.

6. The hookah holder of claim 1, wherein the hookah holder is manufactured by casting silicone in a cast.

7. The hookah holder of claim 1, wherein the ring has a diameter of about 100 mm to about 200 mm.

8. The hookah holder of claim 1, wherein the ring has a cavity running along the ring, the cavity configured to receive the hookah.

9. The hookah a holder of claim 1, wherein the ring has an upper portion and a lower portion, with a cavity formed in between the upper and the lower portion, the cavity configured to receive a hookah base.

10. The hookah a holder of claim 9, wherein the lower portion extends more towards center of the ring than the upper portion

11. The hookah a holder of claim 8, wherein the cavity has a shape of a V with a curved bottom, and an opening towards the center of the ring.

12. A hookah holder comprising:
a) a ring configured for accepting a base of a hookah, a bottom of the ring closed, and a top of the ring open and accessible for placement of the hookah;
b) a plurality of connectors on the bottom of the ring for securing the ring to a surface;
wherein the hookah's in placed inside of the ring and is secured by the hookah holder.

13. The hookah holder of claim 12, wherein a cavity runs along inside of the ring.

14. The hookah holder of claim 12, wherein the connector is a suction cup.

15. The hookah holder of claim 12, wherein the hookah holder is made from silicone.

16. The hookah holder of claim 12, wherein the hookah holder is fabricated from one piece.

17. The hookah holder of claim 12, wherein the ring has a diameter of about 100 mm to about 200 mm.

18. The hookah holder of claim 12, wherein the hookah holder is stretchable by a finger in a horizontal direction.

19. The hookah a holder of claim 12, wherein the ring has an upper portion and a lower portion, with a cavity formed in between the upper and the lower portion, the cavity configured to receive the hookah.

20. A one piece fabricated hookah holder comprising:
a) a ring configured for accepting a base of a hookah, the ring having a cavity inside, the cavity of the ring having an opening, in a direction of center of the ring, running along the ring, and
b) a plurality of connectors placed on a bottom of the ring for securing the ring to a surface;
wherein the hookah is fabricated from silicone;
wherein the hookah in placed inside of the ring and is secured by the hookah holder.
